(19) United States
(12) Patent Application Publication
(10) Pub. No.: US 2026/0309498 A1
(43) Pub. Date: Oct. 8, 2026

(54) NAVIGATION DEVICE AND METHOD USING DATA PRE-INTEGRATED ASYNCHRONOUSLY IN A REMOTE IMU

(71) Applicant: SAFRAN ELECTRONICS & DEFENSE, PARIS (FR)

(72) Inventors: Yves BECHERET, MOISSY-CRAMAYEL (FR); François NEYTARD, MOISSY-CRAMAYEL (FR)

(21) Appl. No.: 19/142,052

(22) PCT Filed: Dec. 12, 2023
(86) PCT No.: PCT/EP2023/085232

§ 371 Date: Jun. 20, 2025

(30) Foreign Application Priority Data
Dec. 21, 2022 (FR) 2214145

(51) Int. Cl. G01C 21/16

(52) U.S. Cl. CPC G01C 21/183; G01C 21/166

(57) ABSTRACT

Navigation device having an inertial measurement unit and an electronic navigation calculation unit connected to each other by a data link, the inertial measurement unit having inertial sensors which supply first signals containing first data representative of a variation in velocity and second data representative of a variation in angle. The electronic navigation calculation unit is arranged to calculate a navigation from signals supplied by the inertial measurement unit. The inertial measurement unit includes an electronic processing circuit connected to the inertial sensors and arranged to perform at least a first integration, as a function of time, of the first data and of the second data over an integration period, which begins at a single integration start time and is measured, in order to produce first processed data and second processed data contained in second signals together with time information representative of the integration period. The electronic navigation calculation unit is arranged to extract the processed data and the time information from the second signals and to process them in order to calculate the navigation while taking the integration period between two successive extractions into account.

The present invention relates to the field of inertial measurement units, more particularly to inertial navigation systems enabling navigation on the basis of measurements supplied by at least one inertial measurement unit.

### BACKGROUND OF THE INVENTION

Inertial navigation systems are known; one example is shown in FIG. 6 under the general reference 1000, comprising, within the same housing, an inertial measurement unit 1100 that is connected by a data link to an electronic navigation calculation unit 1200.

The inertial measurement unit 1100 comprises accelerometers and angular sensors arranged along the axes of a measurement frame of reference [m] for supplying signals that are representative of the integral, over a time step (between a time tᵢ₋₁ and a time tᵢ), of the specific force vector and the angular velocity vector with respect to an inertial frame of reference [i]. The successive signals are thus representative of the integral of both the specific force vector and the angular velocity vector from a time t₀ to a time t₁, then from the time t₁ to a time t₂, then from the time t₀ to a time t₃, etc.; the signals are therefore generally called increments.

The specific force (“g-force” or “mass-specific force”) is a representation of the sum of the acceleration relative to the inertial frame of reference and the Earth's gravity.

The electronic navigation calculation unit 1200 comprises a processor and a memory containing a navigation computer program that is executed by the processor and that processes the signals supplied by the inertial measurement unit 1100 in order to determine a trajectory of the carrier (a vehicle) carrying the navigation system. Since the signals supplied by the inertial measurement unit 1100 are increments indicative of a variation in the location of the carrier and not an absolute value, the navigation calculations have to be carried out at a high frequency, typically from 50 to 200 Hz, in order to ensure that the location is precisely reconstructed in a manner insensitive to the dynamics of the carrier. A clock 1001 allows the inertial measurement unit 1100 and the electronic navigation calculation unit 1200 to be synchronised.

It is understood that a loss of signal, even only briefly, between the inertial measurement unit and the electronic navigation calculation unit is very detrimental since some of the increments are not used.

However, in aircraft, it is envisaged to group the computers together, including the electronic calculation unit of the navigation system, in one or more avionics bays located at the same point on the aircraft. For its part, the inertial measurement unit should preferably be located as close as possible to the centre of gravity of the aircraft. However, in that case, the inertial measurement unit would be connected to the electronic calculation unit, which is arranged in the avionics bay, by an Ethernet link, for example in accordance with the ARINC664 standard.

Any disturbance in the transmission of signals, for example because of a lightning strike, could lead to loss of data and would therefore be detrimental to the navigation precision.

To limit this risk, a fibre optic link could be used, but this is relatively expensive. A specific data exchange protocol could also be used, with redundancy in the data transmission to ensure that no data are lost. However, this results in the link being overloaded and the calculation load increasing.

### OBJECT OF THE INVENTION

The object of the invention is in particular to overcome at least some of the above-mentioned disadvantages.

### SUMMARY OF THE INVENTION

To this end, a navigation device is provided, comprising an inertial measurement unit and an electronic navigation calculation unit that are connected to each other by a data link. The inertial measurement unit comprises inertial sensors which supply first signals containing first data representative of variations in linear velocities and second data representative of variations in angular attitudes. The electronic navigation calculation unit is arranged to calculate a navigation from signals supplied by the inertial measurement unit.

According to the invention, the inertial measurement unit comprises an electronic processing circuit that is connected to the inertial sensors and arranged to perform at least a first integration, as a function of time, of the first data and the second data over an integration period, which is measured from a single integration start time, in order to produce first processed data and second processed data contained in second signals together with time information representative of the integration period. The electronic calculation unit is arranged to extract the processed data and the time information from the second signals and to process them in order to calculate the navigation while taking the integration period between two successive extractions into account.

Thus, it is no longer the first signals (the increments produced by the inertial sensors) which are transmitted at high frequency to the electronic navigation calculation unit as in the prior art, but rather values which are integrated over an unbounded integration period from the single initialisation time (the same for all the first data, corresponding for example to the start-up of the system or to the receipt of an integration start command) and which can be transmitted at the same frequency or at a lower frequency. It is understood that the second signals successively sent by the electronic processing circuit are representative of an integration of the time t₀ at a time t₁, then of the time t₀ at a time t₂, then of the time t₀ at a time t₃, etc. In this way, at whichever time a second signal is received, it is representative of an integration starting from the single integration start time, i.e. t₀ in the above example. This transmission is less restrictive, and the risk of transmission errors is limited. Therefore, processing the data to form the second signals that will be transmitted makes it possible to increase the reliability of both the transmission of the data and the navigation calculation carried out on the basis of said data. Such transmission is advantageous over short distances but also over relatively long distances (several metres).

According to a particular feature of the invention, the electronic processing circuit is arranged to compare the first integrated data with at least one first threshold and, when the first integrated data have a current value above the first threshold, to apply a predetermined shift to the first integrated data in order to bring the first integrated data to a shifted value below the first threshold.

Preferably, the electronic processing circuit is arranged to perform two successive integrations on the first data and, when the first double-integrated data have a current value above a second threshold, to apply a second predetermined shift to the first double-integrated data in order to bring the first double-integrated data to a shifted value below the second threshold.

Thus, according to a particular embodiment, the electronic navigation calculation unit is arranged, each time data are received from the inertial measurement unit, to:
acquire the inertial attitude at the time of the current receipt and to store that of the previous receipt,
reconstruct the variation, between two receipts, in inertial pseudo-velocity in the inertial frame of reference, said variation having been corrected for the effect of the first shifts,
calculate, from the evolution of the position in the inertial frame of reference, corrected for the effect of the second shifts, a term that compensates for the fact that the acceleration in the inertial frame of reference is not constant over the length of time between two receipts;
calculate an evolution in time between the current receipt and the previous receipt.

Preferably, therefore, the electronic navigation calculation unit is arranged, each time data are received from the inertial measurement unit, to:
calculate the evolution of the location since the last receipt from:
   the inertial attitude of the current receipt, the inertial attitude of the previous receipt, the pseudo-velocity variation, the term compensating for the fact that the acceleration in the inertial frame of reference is not constant over the length of time between two receipts, and the evolution in time;
   the last calculated location;
supply, via a navigation algorithm, on the assumption that the apparent acceleration is constant in the navigation frame of reference over the length of time between two receipts, a location that groups together the information regarding attitude, velocity and terrestrial geographical position.

The invention also relates to a method for navigating by means of a navigation device comprising an inertial measurement unit and an electronic navigation calculation unit that are connected to each other by a data link. The method comprises the steps of:
in the inertial measurement unit:
measuring a variation in linear velocities and a variation in angular attitude by means of inertial sensors which supply signals first containing first data representative of the variation in linear velocities and second data representative of the variation in angular attitude,
performing processing that comprises at least a first integration of the first data and the second data over an integration period from a single integration time,
producing first processed data and second processed data contained in second signals together with time information representative of the integration period; and
in the electronic calculation unit:
extracting the processed data and time information from the second signals,
processing them in order to calculate the navigation while taking the integration period between two successive extractions into account.

Lastly, the invention relates to a vehicle having a navigation device according to the invention.

Other features and advantages of the invention become clear on reading the following description of a particular and non-limiting embodiment of the invention.

### BRIEF DESCRIPTION OF THE DRAWINGS

Reference is made to the accompanying drawings, in which:

FIG. 1 is a schematic partial view of an aircraft having a navigation device according to the invention;

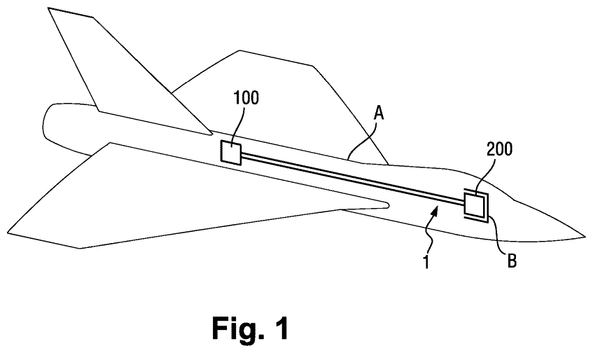

FIG. 2 is a schematic view of the device according to the invention;

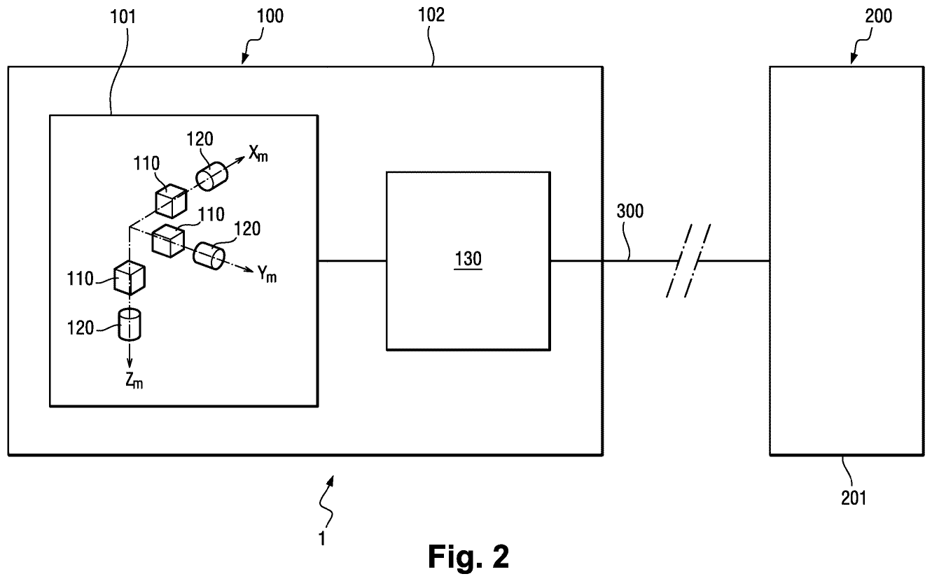

FIG. 3 is a flowchart showing the data exchanges when the method according to the invention is carried out;

FIG. 4 is a flowchart showing the implementation of the method according to the invention, on the inertial measurement unit side;

FIG. 5 is a flowchart showing the implementation of the method according to the invention, on the electronic calculation unit side;

FIG. 6 is a flowchart showing the data exchanges in a navigation device according to the prior art.

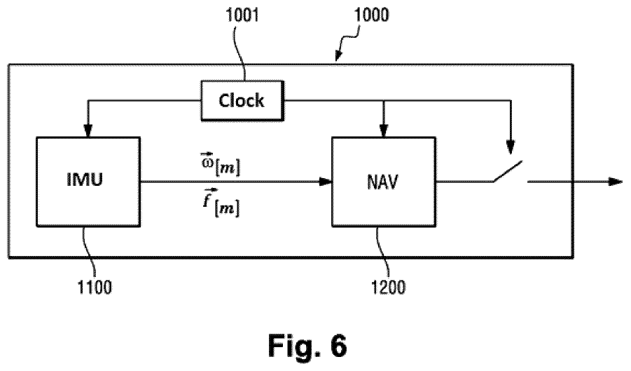

### DETAILED DESCRIPTION OF THE INVENTION

With reference to the drawings, the invention is described here in an aeronautical application, the navigation device of the invention being on board an aircraft A having a structure that comprises a fuselage and wings and having a centre of gravity G.

The navigation device according to the invention, denoted generally by 1, comprises an inertial measurement unit 100 and an electronic navigation calculation unit 200 that are connected to each other by a data link 300. Here, the inertial measurement unit 100 is positioned substantially at the centre of gravity G of the aircraft A, and the electronic calculation unit 200 is positioned at the front of the aircraft A, in an avionics bay B that contains the computers that process the data used for piloting the aircraft A. Thus, the inertial measurement unit 100 is arranged at a first distance from the centre of gravity G, and the electronic navigation calculation unit 200 is arranged at a second distance from the centre of gravity, the first distance being less than the second distance in this case. Here, the difference between the first distance and the second distance is several metres.

The inertial measurement unit 100 comprises a first housing 101 containing inertial sensors, namely linear inertial sensors (more specifically accelerometers 110), arranged along the axes of a measurement frame of reference [m] for measuring the “gravitational velocity” of that frame of reference (i.e. the time integral of the specific force present at the centre of the frame of reference), and also angular inertial sensors (in this case gyroscopes 120) arranged along the axes of said frame of reference to measure the rotation of the measurement frame of reference [m] with respect to an inertial frame of reference [i]. The inertial sensors do not supply absolute values but rather increments representative of a variation in the measured quantity compared with the previous measurement. The inertial frame of reference [i] is, for example, the measurement frame of reference when the inertial measurement unit 100 is powered up, or any other inertial frame of reference angularly shifted with respect thereto. The increments of the integral of the specific force are thus representative of a variation in the components of the gravitational velocity along the three axes of the frame of reference [m]. The rotational increments are thus representative of the variation in the time integral of the angular rotational velocity of the measurement frame of reference [m] with respect to the inertial frame of reference [i] and are supplied in the form of quaternions, Euler angles, rotation matrices or Bortz vectors. The inertial sensors thus supply first signals containing first data representative of a variation in the gravitational velocity (accelerometric measurement) and second data representative of an angle variation (gyroscopic measurement). Conventionally, these signals are supplied at a rate of between 100 Hz and 400 Hz.

The first housing 101 is received in a second housing 102 of the inertial measurement unit 100. The second housing 102 also contains an electronic processing circuit 130 having inputs connected to the outputs of the inertial sensors 110, 120, for example by electrical conductors such as tracks or cables. Here, the electronic processing circuit 130 comprises at least one processor and one memory containing a first computer program which is executable by the processor and which comprises instructions arranged to carry out the method of the invention. This first program will be explained further below.

The electronic navigation calculation unit 200 is known per se and comprises a housing 201 that contains at least one processor and one memory containing a second computer program which is executable by the processor and which comprises instructions arranged to carry out the method of the invention. In general, the electronic navigation calculation unit 200 is arranged to calculate an inertial navigation from the signals supplied by the inertial measurement unit 100. This second program will also be explained further below.

The inertial measurement unit 100 and the electronic navigation calculation unit 200 each have a clock that allows firstly the transmitted signals and secondly the receipt times to be dated.

The inertial measurement unit 100 and the electronic navigation calculation unit 200 are physically separated from each other but are connected so as to exchange signals. Thus, the electronic processing circuit 130 has at least one output connected to at least one input of the electronic navigation calculation unit 200 via the data link 300. Here, the data link 300 is an Ethernet link in accordance with the ARINC664 standard, for example.

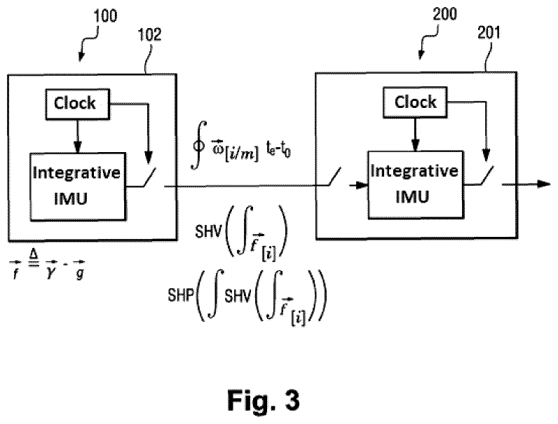

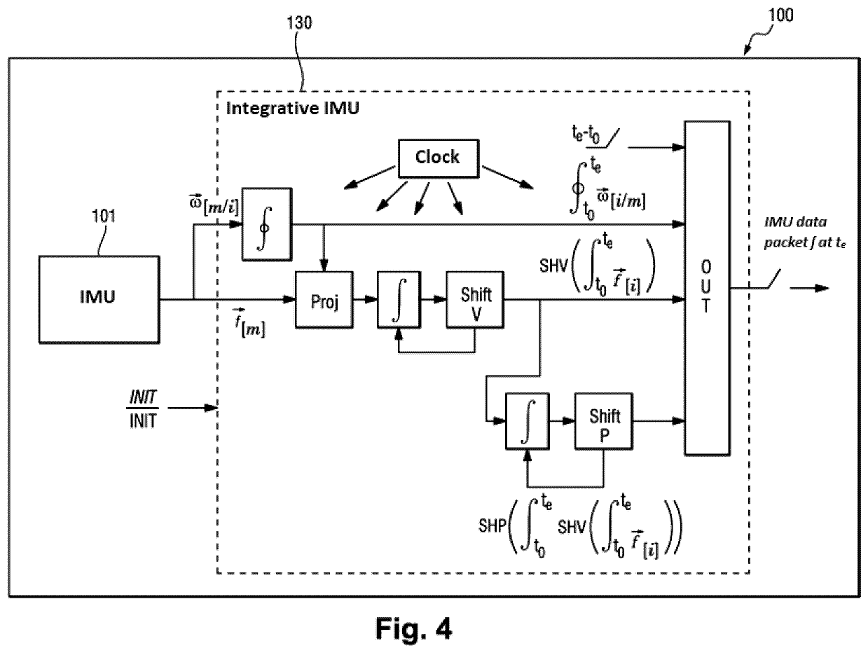

The first program executed by the electronic processing circuit 130 receives, as an input, the first signals containing the first data and the second data. It is arranged to perform:
a first integration, over an integration period measured from a single integration start time to (the integration period is denoted by tₑ-t₀ in FIGS. 3 and 4), of the second data in order to produce second integrated data;
a projection of the first data into the inertial frame of reference [i] in order to obtain first projected data;
a first integration of the first projected data, over the integration period measured from the single integration start time t₀, in order to produce first integrated data;
a first shift (Shift V) of the first integrated data in order to obtain first processed data (the first shift is performed when the value of the first integrated data goes beyond a value range that is acceptable for the subsequent processing of those data);
a second integration of the first processed data, over the integration period measured from the single integration start time t₀, in order to produce first double-integrated data;
a second shift (Shift P) of the first double-integrated data in order to obtain first double-processed data (the second shift is performed when the value of the first double-integrated data goes beyond a value range that is acceptable for the subsequent processing of those data).

The first program executed by the electronic processing circuit is arranged to calculate the floating-point or fixed-point integrations using a number of mantissa bits that makes it possible to achieve the required location precision with a minimum time between two successive shifts of 20 s. A double-precision calculation on 64 bits, of which 48 are mantissa bits, makes it possible to achieve a precision goal of, for example, 0.001 m·s⁻¹, 0.001 m, 0.001°/h and 1 μrad.

It is understood that:
the second integrated data are representative of an angular position (or an orientation);
the first integrated data and the first processed data are representative of a linear velocity;
the first double-integrated data and the first double-processed data are representative of a linear position.

The first shifting operation comprises the step of comparing an absolute current value of each component of the first integrated data with at least one first threshold SVelocity. When the components of the first integrated data have absolute current values below the first threshold, the first program leaves the current values unchanged, which is equivalent to applying a zero shift. When one of the components of the first integrated data has an absolute current value above the first threshold, the first program applies a predetermined shift to said component of the first integrated data in order to bring said component of the first integrated data to a shifted value below the first threshold. In other words, a first shift value SHV (here equal to the first threshold SVelocity) is deduced from the current value of said component of the first integrated data (or added to it depending on the sign of the current value) in order to obtain the shifted value. This makes it possible to keep the value of each component of the first data within a value range [−SVelocity; +SVelocity]. The first threshold SVelocity is determined depending on an expected velocity resolution for the navigation. The shift-free integration period obviously depends on the dynamics of the aircraft A. Here, the first integrated data and the first shift value SHV are expressed in metres per second.

The second shifting operation comprises the step of comparing an absolute current value of the first double-integrated data with at least one second threshold SPosition. When the components of the first double-integrated data have absolute current values below the first threshold, the first program leaves the current values unchanged, which is equivalent to applying a zero shift. When the value of one of the components of the first double-integrated data exceeds the second threshold, the first program applies a predetermined shift to said component of the first double-integrated data in order to bring said component of the first double-integrated data to a shifted value below the second threshold. In other words, a second shift value SHP (here equal to the second threshold SPosition) is deduced from the current value of the first double-integrated data (or added to it depending on the sign of the current value of said component) in order to obtain the shifted value. This makes it possible to keep the value of each component of the first double-integrated data within a value range [−SPosition; +SPosition]. The second threshold SPosition is determined depending on an expected position resolution for the navigation. The shift-free integration period depends on the dynamics of the aircraft A and the threshold SPosition. Here, the first double-integrated data and the second shift value SHP are expressed in metres.

The first processed data (which correspond to the three velocity components including the integration of the effect of gravity, which may be affected by a shift and are thus referred to as the pseudo-velocity PV), the first double-processed data (which correspond to the three position components including the double integration of the effect of gravity, which may be affected by one shift—velocity or position—or by two shifts—velocity and position—and are thus referred to as the pseudo-position PP), the second processed data (which correspond to the three components of the rotation that is representative of the attitude of aircraft the A) and time information (an integration-step or time-step of counter the inertial measurement unit between the sampling time and the single integration start time, i.e. tₑ-t₀ here) are transformed into a packet that is introduced into second signals transmitted via the data link 300 to the electronic navigation calculation unit 200.

The second program executed by the electronic navigation calculation unit 200 is arranged to extract the processed data and the time information from the second signals and to process them in order to calculate the navigation while taking into account the evolution of the integration period since the last extraction of the second signals.

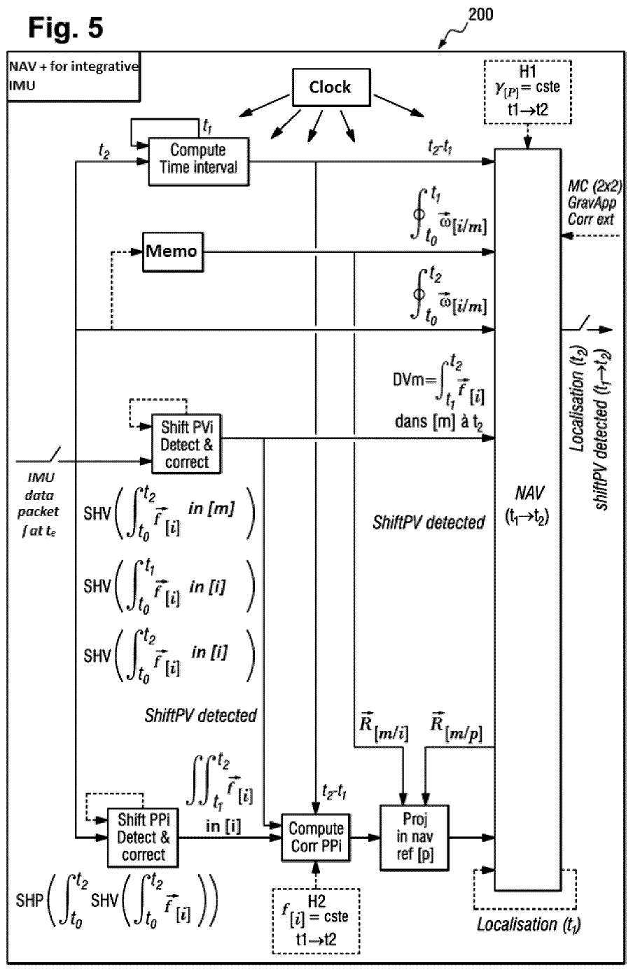

More precisely, with reference to FIG. 5, the second program receives, as an input, the second signals in the form of two data packets that are transmitted at each time tₑ by the first program but recovered, respectively, at the time t₁ then at the time t₂, for example, each comprising the first processed data, the first double-processed data, the second processed data and time information corresponding to the sampling time of the pseudo-navigation data in the inertial measurement unit together with any internal drifts of the clock of the inertial measurement unit (this time information is a number of integration steps of the inertial measurement unit since the single integration start time t₀, associated with the data packet transmitted by the inertial measurement unit).

The two times t₁ then t₂ are separated by less than half the minimum time between two successive shifts of a component of the inertial pseudo-velocity or pseudo-position.

Considering, for the simplicity of the description, that the data received at the time t₁ have already been processed, the second program has to carry out the operations for calculating the following on the basis of the data received at the time t₂:
the three components of the variation in the inertial pseudo-velocity from t₁ to t₂ in the measurement frame of reference [m], denoted by DVm(t₁->t₂), said components having been corrected for the effect of a shift SHV;
the three components of the variation in the inertial pseudo-velocity from t₁ to t₂ in the inertial frame of reference [i], denoted by DVi(t₁->t₂), said components having been corrected for the effect of a shift SHV;
the three components of the variation in the inertial pseudo-position from t₁ to t₂ in the inertial frame of reference [i], denoted by DP(t₁->t₂), said components having been corrected for the effect of a shift SHP;
the three correction components of the inertial pseudo-position from t₁ to t₂ in the inertial frame of reference [i], denoted by CorrPPi(t₁->t₂),
a logic indicator ShiftPVdetected for detecting a shift of at least one of the pseudo-velocity components between t₁ and t₂.

It is noted that the data received at the time t₁ and the data received at the time t₂ have been integrated from the integration start time t₀. It is therefore sufficient to subtract the data received at the time t₁ from those received at the time t₂ in order to obtain the data corresponding to the time interval t₂−t₁.

Furthermore, the second program has the shift values and is arranged to analyse the values of the transmitted processed data and to detect the presence of a shift. The analysis involves comparing each of the components of the most recently received processed data with each of the components of the processed data received the previous time and detecting therein any inconsistency in consideration of the possible dynamics of the vehicle and the laws of physics. If any such inconsistency exists, this means that a shift has occurred, and the second program then considers the indicator ShiftPVdetected to be true and compensates for the implemented shift by using the corresponding shift value. Otherwise, the second program considers the indicator ShiftPVdetected to be false.

The second program calculates the evolution of the inertial location from t₁ to t₂ from the following information:
inertial attitude (transmitted by the electronic processing circuit 130) at t₁ and t₂,
variation in the inertial pseudo-velocity in the inertial frame of reference from t₁ to t₂,
length of time t₂−t₁,
location at t₁.
   In a manner known per se, the second program is also arranged to process:
the curvature matrix MC for determining the local curvature of the reference ellipsoid for navigation relative to the Earth,
the local apparent gravity GravApp (locally perpendicular to the ellipsoid),
an external correction factor Corr ext for correcting the calculation of the apparent gravity by stabilising the altitude.

The second program performs these calculations of the evolution of the inertial location from t₁ to t₂ on the assumption H1 that the apparent acceleration γₚ is constant in the navigation frame of reference between t₁ and t₂.

These calculations are then corrected by taking into account the three correction components of the inertial position from t₁ to t₂ in the inertial frame of reference [i].

The three correction components of the inertial position from t₁ to t₂ in the inertial frame of reference [i], CorrPPi(t₁->t₂), are calculated as follows:
if ShiftPVdetected is false (no velocity shift), then

$$CorrPPi ( {t}_{1} -> {t}_{2} ) = DP ( {t}_{1} -> {t}_{2} ) - ( PV ( {t}_{1} ) + PV ( {t}_{2} ) ) * ( {t}_{1} - {t}_{2} ) / 2$$

if ShiftPVdetected is true (there has been a velocity shift between t₁ and t₂), then the value of CorrPPI cannot be calculated and is arbitrarily set to 0, i.e. CorrPPi(t₁->t₂)=0

This calculation is performed on the assumption H2 that the acceleration fi in the inertial frame of reference [i] is constant. The difference between the assumptions H1 and H2 is mainly due to the apparent gravitational rotation seen from the navigation reference frame p in the inertial frame of reference [i]. For horizontal mechanised navigation on the terrestrial, free-azimuth reference ellipsoid, this difference a has negligible effect on the calculated position-deviation correction term CorrPPi(t₁->t₂). It is understood that the indicator ShiftPVdetected is determined in order for the evaluation of the variations in inertial location errors to be refined according to the potential dynamics of the carrier at that time.

The second program corrects the inertial location using a deviation CorrPi calculated as follows:
projecting the components of CorrPPi(t₁->t₂) in the navigation reference frame [p] from the inertial reference frame [i], which gives the correction components CorrPPp(t₁->t₂), using:
   the inertial attitude transmitted by the electronic processing circuit 130 at t₁ and possibly at t₂,
   the attitude of the navigation at t₁;
calculating the equivalent rotation correction of the attitude and calculating the horizontal position on Earth of the horizontal location by using the apparent gravity (GravApp) and the matrix MC (2×2) of the local curvature of the terrestrial ellipsoid of the navigation in the horizontal navigation frame of reference [p] and the two horizontal correction components CorrPPp(t₁->t₂);
taking this additional rotation into account in the calculations of the evolution of the inertial location from t₁ to t₂;
adding the vertical correction component CorrPPp(t₁->t₂) to the altitude at t₂, which is the result of calculating the evolution of the inertial location from t₁ to t₂ to obtain CorrPi.

These corrected data are then used by the second program via a navigation algorithm, which is known per se, to supply the location of the aircraft A (the location groups together the information regarding attitude, velocity and terrestrial geographical position).

It should be noted that, preferably, the electronic navigation unit has a working period of less than half the minimum time between two successive shifts.

The present invention relates to the integration of these increments, by the inertial measurement unit, in an inertial frame of reference (within the limits of sensor faults) so as to enable calculations of navigation on a terrestrial reference ellipsoid at a lower frequency and in an asynchronous manner. The use by the second program of the outputs of the inertial measurement unit in the event that shifts are possible is based on the knowledge and processing of the inertial pseudo-velocity and pseudo-position shift values before the evolution of the inertial location is calculated.

It goes without saying that the invention is not limited to the described embodiment but covers any variant falling under the scope of the invention as defined by the claims.

In particular, the device may have a different structure from that described.

For example, the electronic processing circuit and the electronic navigation calculation unit may have different structures from those described and may comprise, for example, ASIC-type processor, a coprocessor, a dedicated a microcontroller, an FPGA-type programmable circuit, etc.

Although the invention is particularly advantageous when the inertial measurement unit and the electronic processing unit are very far apart (for example several metres apart), the invention is also applicable when the inertial measurement unit and the electronic processing unit are closer together (for example less than one metre apart). The second distance is not limited by the first distance; the second distance may be less than, greater than or equal to the first distance depending on requirements and the configuration of the vehicle.

Computer programs may be arranged differently and perform calculations with different levels of precision.

Shifting operations are not needed when the integration period is such that the processed data supplied have a value that is compatible with the expected resolution for the navigation.

The outputs of the electronic processing circuit may be supplied at a fixed rate (possibly configurable via a circuit initialisation command) or on external request, in which case the program making the request is responsible for ensuring the request rate is sufficient so as not to risk the same data being shifted more than once between two data supplies.

Preferably, the attitude outputs (gyrometric data), the velocity outputs and the position (from outputs the accelerometric data) are all limited to 22 or 24 bits per output, with a sufficient resolution to ensure that the drop in navigation precision with the method of the invention is negligible compared with the precision of navigation carried out directly on the basis of the increments from the sensors. The described shifts allow the number of bits of the velocity and position outputs to be reduced.

The outputs of the electronic processing circuit enable inertial navigation that:
is synchronous or asynchronous,
is precise even when the outputs are processed at a rate greater than a few seconds and for a dynamic trajectory,
is robust against multiple interruptions potentially lasting up to several seconds, or more than one minute when static,
does not lead to the electronic navigation calculation unit being overloaded in the event of data loss.
   Preferably, the first program executed by the electronic processing circuit has an initialisation mode by which all or some of the following parameters can be modified:
orientation of the measurement frame of reference,
clocked output or output on request,
output rate,
type of velocity output (in the measurement frame of reference or in the inertial frame of reference),
shift thresholds,
shift values,
scale factor bias or errors, etc.

Preferably, to minimise the projection error in the navigation frame of reference, navigation with inertial or horizontal free-azimuth mechanisation (and navigation frame of reference) on the terrestrial ellipsoid is selected. However, this is not essential.

Preferably, the effects of the variation in gravity, local curvature of the ellipsoid and Coriolis acceleration between the times t₀ and tₑ are disregarded.

In the event that a plurality of shifts have to be carried out after a single integration, it is necessary to add a shift counter to the data packet so that the electronic calculation unit can retrieve the number of shifts carried out.

The length of time between two shifts can range from a few seconds to a few tens of seconds depending on the dynamics of the vehicle carrying the navigation device.

Preferably, to maintain good navigation precision, the number of shifts per hour is limited. For example, with outputs encoded on 24 bits, the maximum number of shifts is advantageously three per 400-s period, and with outputs encoded on 32 bits, the maximum number of shifts is advantageously three per 28-hour period.

The device may comprise one or more inertial measurement units, arranged or not arranged near one another, at any point on the aircraft and in particular not necessarily near the centre of gravity.

In a basic navigation form, it is possible to reconstruct the increments at the conventional navigation rate from the differences between two successive sets of output data of the inertial measurement unit. The inertial navigation can be kept at this rate in the same way as with conventional navigations. In this case, the correction vector CorrPPi is systematically zero.

The invention is applicable to any type of vehicle, whether land, water or air.

1. A navigation device comprising an inertial measurement unit and an electronic navigation calculation unit that are connected to each other by a data link, the inertial measurement unit comprising inertial sensors which supply first signals containing first data representative of a variation in velocity and second data representative of a variation in angle, and the electronic navigation calculation unit being arranged to calculate a navigation from signals supplied by the inertial measurement unit, wherein the inertial measurement unit comprises an electronic processing circuit that is connected to the inertial sensors and arranged to perform at least a first integration, as a function of time, of the first data and of the second data over an integration period, which begins at a single integration start time and is measured, in order to produce first processed data and second processed data contained in second signals together with time information representative of the integration period, and in that the electronic navigation calculation unit is arranged to extract the processed data and the time information from the second signals and to process them in order to calculate the navigation while taking the integration period between two successive extractions into account.

2. The device according to claim 1, wherein the electronic processing circuit is arranged to perform a second integration on the result of the first integration of the first data, the processed data comprising the result of the first integration and the result of the second integration.

3. The device according to claim 1, wherein the electronic processing circuit is arranged to compare the first integrated data with at least one first threshold and, when the first integrated data have a current value above the first threshold, to apply a first predetermined shift to the first integrated data in order to bring the first integrated data to a shifted value below the first threshold.

4. The device according to claim 3, wherein the electronic processing circuit is arranged to perform two successive integrations on the first data and, when the first double-integrated data have a current value above a second threshold, to apply a second predetermined shift to the first double-integrated data in order to bring the first double-integrated data to a shifted value below the second threshold.

5. The device according to claim 4, wherein the electronic navigation calculation unit is arranged, each time the data are received from the inertial measurement unit, to:
acquire the inertial attitude at the time of the current receipt and to store that of the previous receipt,
reconstruct the variation, between two receipts, in inertial pseudo-velocity in the inertial frame of reference, said variation having been corrected for the effect of the first shifts,
calculate, from the evolution of the position in the inertial frame of reference, corrected for the effect of the second shifts, a term that compensates for the fact that the acceleration (f[i]) in the inertial frame of reference [i] is not constant over the length of time between two receipts;
calculate an evolution in time between the current receipt and the previous receipt.

6. The device according to claim 5, wherein the electronic navigation calculation unit is arranged, each time data are received from the inertial measurement unit, to:
calculate the evolution of the location since the last receipt from:
the inertial attitude of the current receipt, the inertial attitude of the previous receipt, the pseudo-velocity variation, the term compensating for the fact that the acceleration (f[i]) in the inertial frame of reference [i] is not constant over the length of time between two receipts, and the evolution in time;
the last calculated location;
supply, via a navigation algorithm that is known per se, on the assumption that the apparent acceleration is constant in the navigation frame of reference over the length of time between two receipts, a location that groups together the information regarding attitude, velocity and terrestrial geographical position.

7. The device according to claim 4, wherein the first threshold and the second threshold are determined depending on an expected resolution for the navigation.

8. The device according to claim 3, wherein the electronic navigation unit has a working period of less than half the minimum time between two successive shifts.

9. The device according to claim 1, wherein the electronic processing circuit is arranged to transmit the second signals at the request of the electronic navigation calculation unit.

10. The device according to claim 1, wherein the electronic processing circuit is arranged to transmit the second signals at predetermined time intervals.

11. The device according to claim 1, wherein the electronic processing circuit is arranged to calculate the floating-point integrations with double precision on 64 bits, of which 48 are mantissa bits.

12. The device according to claim 1, wherein the inertial measurement unit and the electronic navigation calculation unit are in two separate housings, and the data link is of the Ethernet type.

13. A method for navigating by means of a navigation device comprising an inertial measurement unit and an electronic navigation calculation unit that are connected to each other by a data link, comprising the steps of:
in the inertial measurement unit:
measuring an accelerometric variation and a gyrometric variation by means of inertial sensors which supply first signals containing first data representative of an accelerometric variation and second data representative of a gyrometric variation,
performing processing that comprises at least a first integration of the first data and the second data over a predetermined integration period,
producing second signals comprising the first processed data and the second processed data and time information; and
in the electronic navigation calculation unit:
extracting the processed data and time information from the second signals,
processing them in order to calculate the navigation while taking the integration period into account.

14. A vehicle containing at least one device according to claim 1.
